(19) United States
(12) Patent Application Publication
(10) Pub. No.: US 2009/0115421 A1
(43) Pub. Date: May 7, 2009

(54) Battery gauge for trolling motor

(76) Inventors: Stephen Wixon, Novi, MI (US); Norma Wixon, Novi, MI (US)

Correspondence Address: GALASSO & ASSOCIATES, LP, P.O. BOX 26503, AUSTIN, TX, 78755-0503, US

(21) Appl. No.: 11/983,186

(22) Filed: Nov. 7, 2007

(51) Int. Cl. G01N 27/416

(52) U.S. Cl. 324/435

(57) ABSTRACT

Battery Gauge for Trolling Motor is a gauge for measuring the amount of voltage remaining in a boat battery. The preferred embodiment of the invention utilizes a gauge having a scale, a battery level indicator, cables and cable terminals to connect to battery terminals. To use the preferred embodiment of Battery Gauge for Trolling Motor, an individual would attach the cable terminals to the battery terminals of a boat using the securing wingnut. The battery level indicator can then be monitored on the gauge to determine when the battery power is at a critical level. Ideally, the gauge would be placed on the trolling motor, near the boat battery housing or on the dash of the boat.

### CROSS REFERENCE TO RELATED APPLICATIONS

This United States Non-Provisional patent application does not claim priority to any United States Provisional patent application or any foreign patent application.

### FIELD OF THE DISCLOSURE

The disclosures made herein relate generally to the boating accessories industry. The invention discussed herein is in the general classification of battery power gauges.

### BACKGROUND

Millions of people in the United States work to provide their families with necessities. Many individuals also work to provide luxury items and entertainment. Lake and beach homes and boats are increasingly popular luxury items, permitting owners to enjoy various boating activities. Water sports such as jet skiing, water skiing and wakeboarding are popular activities at both lake and beach homes.

Safety, however, is always a concern when boating in a lake or ocean. Boaters often experience operating difficulties on the boat. Mechanical problems can make it difficult to return the boat and passengers to the shore. Batteries running out of power are another common cause of operating difficulties. Currently, boats do not have an adequate method and device for monitoring the amount of voltage remaining in a battery.

A brief review of the internal components of typical voltage and current measuring meters and gauges is useful to understand how the gauge of the present invention will operate on a boat. Both current and voltage can be measured with an electromechanical or electronic meter/gauge. An electromechanical meter has a coil of wire that pivots in a nearly friction-free bearing and has a needle attached to it. This coil also has a spring attached to it and that spring tends to restore the coil and needle to their zero orientation. Because the spring opposes any rotation of the coil and needle, the orientation of the needle depends on any other torque (twist) experienced by the coil of wire. The more torque the spring-loaded coil experiences, the farther the coil and needle will turn away from the zero orientation. The needle's angle of deflection is proportional to the extra torque on the coil.

The extra torque exerted on the spring-loaded coil comes from magnetic forces. There is a permanent magnet surrounding the coil, so that when current flows through the coil from connecting battery terminals to the cables of the device, the coil experiences a torque. Because a current-carrying coil is magnetic, the coil's magnetic poles and the permanent magnet's magnetic poles exert forces on one another and the coil experiences a torque. This magnetic torque is exactly proportional to the current flowing through the coil. Because the torque on the coil is proportional to the current and the needle's angle of deflection is proportional to this torque, the needle's angle of deflection is exactly proportional to the current in the wire.

To use such a meter as a current meter (an ammeter), an individual must allow the current flowing through the circuit to pass through the meter. An individual must open the circuit and insert this ammeter in series with the rest of the circuit. The current flowing through the circuit will also flow through the meter and its needle will move to indicate how much current is flowing.

To use such a meter as a voltage meter (a voltmeter), some current is diverted from the circuit to the meter through an electric resistor and then returned to the circuit. The amount of current that follows this bypass and flows through the electric resistor is proportional to the voltage difference across that resistor (a natural phenomenon described by Ohm's law). The voltmeter system thus diverts from the circuit an amount of current that is exactly proportional to the voltage difference between the place at which current enters the voltmeter and where it returns to the circuit. The needle's movement thus reflects this voltage difference.

In an electronic voltmeter, sensitive electronic components directly measure the voltage difference between two wires. Virtually no current flows between those two wires, so that the meter simply makes a measurement of the charge differences on the two wires.

Hence, there is a need in the art for a convenient to use, inexpensive, durable, safe and effective device for using existing technology to monitor the voltage in a boat battery.

### SUMMARY OF THE DISCLOSURE

Battery Gauge for Trolling Motor is a gauge for measuring the amount of voltage remaining in a boat battery.

The preferred embodiment of the invention utilizes a gauge having a scale, a battery level indicator, cables and cable terminals to connect to battery terminals.

The principal object of this invention is to provide a device for determining the amount of voltage remaining in a battery.

Another object of this invention is to provide a device to aid a boater in deciding the distance to travel from the shore based on the battery voltage.

Another object of this invention is to provide a device for observing the amount of power consumption occurring during a boating outing.

Another object of this invention is to provide an affordable device for monitoring the battery power remaining on a boat.

Another object of this invention is to provide a safe device for monitoring the battery power remaining on a boat.

Yet another object of this invention is to provide a durable device for monitoring the battery power remaining on a boat.

### BRIEF DESCRIPTION OF THE DRAWINGS

FIG. 1 depicts a perspective view of the preferred embodiment of the invention.

FIG. 2 depicts a perspective view of the preferred embodiment of the invention attached to a battery.

FIG. 3 depicts close-up view of the attaching mechanism of the preferred embodiment of the invention to the battery.

### DETAILED DESCRIPTION OF THE DRAWINGS

The preferred embodiment of Battery Gauge for Trolling Motor is comprised of at least some of the following: a gauge having a scale, a battery level indicator, cables and cable terminals to connect to battery terminals.

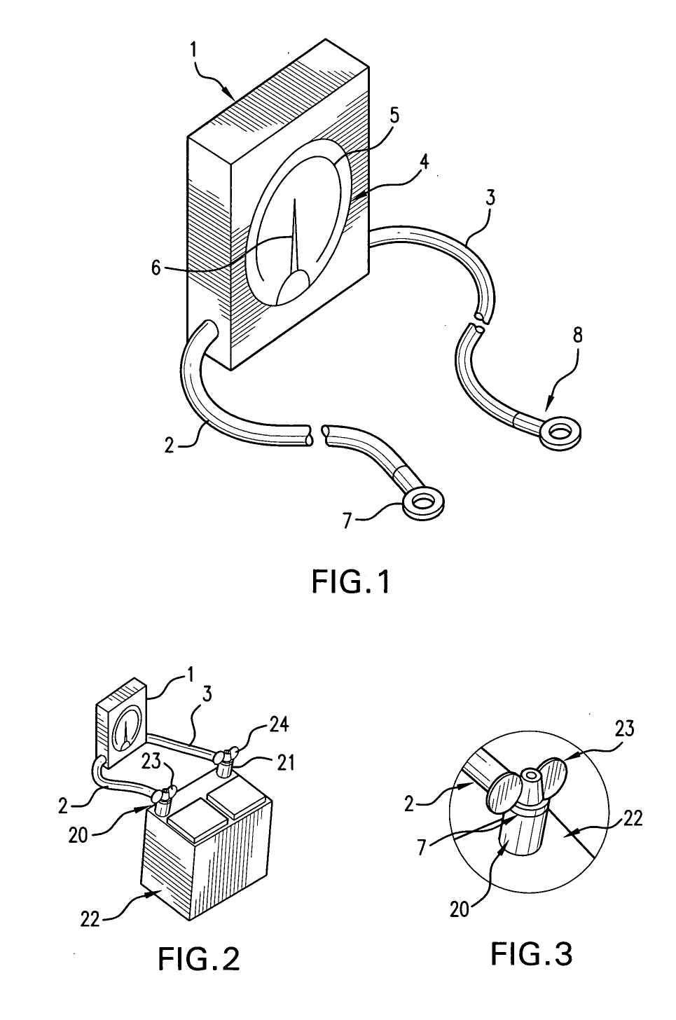

FIG. 1 depicts a perspective view of the preferred embodiment of the invention. A housing 1 for a gauge has a first cable 2 and a second cable 3. The first cable 2 emanates from one side of the housing 1 while the second cable 3 emanates from the opposite side of the housing 1 in this preferred embodiment. The housing 1 is made of plastic and approximately rectangular in this preferred embodiment though a variety of materials and shapes could be utilized. The preferred embodiment of the housing 1 is five inches in length, four inches in width and one inch in thickness though other sizes could also be utilized. The housing 1 can come in a variety of colors to match a variety of boats designs.

A battery compartment (not pictured) is located on the rear of the housing 1 to permit a user to install batteries to power the gauge. The first cable 2 and the second cable 3 are approximately six inches long in this preferred embodiment and a quarter of an inch in diameter. The first cable 2 and the second cable 3 have insulation to protect the internal wires. A first cable terminal 7 and a second cable terminal 8 are located on the end of the first cable 2 and the second cable 3. The first cable terminal 7 and the second cable terminal 8 are circular and serve as metal contact points to connect with boat battery terminals.

The housing 1 has a display cover 4 that is transparent in this preferred embodiment though a translucent display cover would also be appropriate. The display cover 4 is circular in shape in this preferred embodiment though other shapes would also suffice. The display cover 4 is located above a scale 5 numbered from zero volts to twelve volts. A battery level indicator 6 is centrally connected to the scale 5 and rotates across the scale 5 to point to the measured voltage when a user connects the first cable terminal 7 and the second cable terminal 8 to the battery terminal (not shown). The left side of the scale 5 has a red zone from zero volts to six volts to indicate lower battery power.

FIG. 2 depicts a perspective view of the preferred embodiment of the invention attached to a battery. The first cable terminal and the second cable terminal are attached to the first battery terminal 20 and the second battery terminal 21 at the top of a standard battery 22. A first wingnut 23 and a second wingnut 24 are located on top of the first battery terminal 20 and the second battery terminal 21 to secure the first cable terminal and the second cable terminal to the first battery terminal 20 and the second battery terminal 21. The first cable 2, the second cable 3, and the housing 1 are also visible in this view.

FIG. 3 depicts close-up view of the attaching mechanism of the preferred embodiment of the invention to the battery. The first cable terminal 7 at the end of the first cable 2 attaches around the first battery terminal 20 on top of the battery 22. The first wingnut 23 is then tightened onto the first cable terminal 7 to firmly secure it to the first battery terminal 20.

To use the preferred embodiment of Battery Gauge for Trolling Motor, an individual would insert batteries into the battery compartment of the housing. Next, he would attach the cable terminals at the end of the cables to the battery terminals on the battery of the boat using the securing wingnut. The battery level indicator can then be monitored to determine when the battery power is at a critical level. Ideally, the gauge would be located on the trolling motor, near the boat battery housing or on the dash of the boat.

The materials utilized for Battery Gauge for Trolling Motor may vary widely but will likely include metals, plastic and electronic components. The metals would ideally be selected from available steel or alloys of steel and aluminum. The production process related to the use of these metals insures that the metal is non-corrosive, durable and strong. The selected metal should have high impact strength and be capable of accepting and retaining coloring materials for an extended length of time.

The plastic used in the production will ideally be selected for durability and longevity. Thermoplastics are commonly used in the manufacturing of components similar to those used in this invention. Polyethylene, polypropylene, and other similar thermoplastic materials would be among those with the necessary traits. Members of this family are recognized universally as being versatile and of high quality.

The plastic components of Battery Gauge for Trolling Motor can also be formed with the use of plastic molding techniques, such as injection molding or blow molding. Injection molding requires melted plastic to be forcefully injected into relatively cool molds. As the plastic begins to harden, it takes on the shape of the mold cavity. This technique is ideal for the mass production of products. Alternatively, blow molding, a form of extrusion, could be utilized. Blow molding involves a molten tube being pushed into a mold. Compressed air then forces the molten tube against the cold walls of the mold.

All electronic components of the invention will also be ideally selected from those currently having the highest industry ratings. These components will also meet and/or exceed all safety and usage regulations. Wiring and associated connecting hardware should be insulated and otherwise protected from intrusion by any harmful or degrading elements, including water, medium level temperatures, and low to medium impact force.

While this device is discussed in conjunction with boat batteries, it could be utilized on a variety of other motorized vehicles, particularly those for use in the water that do not currently utilize such technology.

It should be obvious that the components of the present invention can be of various shapes and sizes. It should also be obvious that the components of the invention can be made of different types of metals, plastics or other suitable materials and can be of any color.

It will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as set forth in the claims.

What is claimed is:

1. A battery monitoring device comprising:
(a) a housing for a gauge;
(b) a first cable and a second cable emanating from the housing;
(c) a first cable terminal on the end of the first cable and a second cable terminal on the end of the second cable;
(d) a scale located on the housing; and
(e) a battery compartment on the housing.

2. The device of claim 1 wherein the first cable and the second cable are located on opposite sides of the housing.

3. The device of claim 1 wherein the housing is made of plastic.

4. The device of claim 1 wherein the housing is approximately rectangular.

5. The device of claim 4 wherein the housing is five inches in length, four inches in width and one inch in thickness.

6. The device of claim 1 wherein the battery compartment is located on the rear of the housing.

7. The device of claim 1 wherein the first cable and the second cable are approximately six inches long and a quarter of an inch in diameter.

8. The device of claim 1 wherein the first cable and the second cable are insulated.

9. The device of claim 1 wherein the first cable terminal and the second cable terminal are circular.

10. The device of claim 1 further comprising
a display cover above the scale.

11. The device of claim 10 wherein the display cover is transparent.

12. The device of claim 10 wherein the display cover is translucent.

13. The device of claim 10 wherein the display cover is circular.

14. The device of claim 1 wherein the scale is numbered from zero volts to twelve volts.

15. The device of claim 1 further comprising
a battery level indicator centrally connected to the scale that rotates across the scale.

16. The device of claim 1 further comprising
a red zone on the scale.

17. The device of claim 1 further comprising
a first wingnut and a second wingnut to connect the first cable terminal and the second cable terminal to a first battery terminal and a second battery terminal

18. A method of monitoring a boat battery comprising the steps of:
(a) locating a battery on a boat;
(b) attaching a housing for a gauge to the boat;
(c) connecting a first cable terminal on the end of a first cable emanating from the housing and a second cable terminal emanating from the end of a second cable to the battery of the boat; and
(d) observing a scale having a battery level indicator in the housing and located underneath a display cover.

19. A battery monitoring device comprising:
(a) a housing for a gauge;
(b) a first cable and a second cable emanating from opposite sides of the housing;
(c) a first cable terminal that is approximately circular on the end of the first cable and a second cable terminal that is approximately circular on the end of the second cable;
(d) a display cover that is approximately circular and transparent above a scale with a range of zero volts to twelve volts on the front of the housing;
(e) a battery level indicator centrally connected to the scale that rotates across the scale;
(f) a red zone on the scale; and
(g) a battery compartment on the housing.

20. The device of claim 19 further comprising
a first wingnut and a second wingnut to connect the first cable terminal and the second cable terminal to a first battery terminal and a second battery terminal.
